(19) United States
(12) Patent Application Publication
(10) Pub. No.: US 2020/0019233 A1
(43) Pub. Date: Jan. 16, 2020

(54) INFORMATION PROCESSING APPARATUS, INFORMATION PROCESSING METHOD, AND PROGRAM

(71) Applicant: SONY CORPORATION, TOKYO (JP)

(72) Inventors: TAKUYA IKEDA, TOKYO (JP); OSAMU SHIGETA, IBARAKI (JP); SEIJI SUZUKI, KANAGAWA (JP); AYA KAWAI, TOKYO (JP); YASUSHI MATOBA, TOKYO (JP); ITIRO SIIO, TOKYO (JP)

(21) Appl. No.: 16/485,884

(22) PCT Filed: Feb. 8, 2018
(86) PCT No.: PCT/JP2018/004291

§ 371 Date: Aug. 14, 2019

(30) Foreign Application Priority Data
Feb. 22, 2017 (JP) 2017-031076

(51) Int. Cl. G06F 3/01; G06F 3/14; G06K 9/00; G06Q 10/06

(52) U.S. Cl. CPC G06F 3/011; G06F 3/14; G06K 9/00362; G06F 3/04842; G06F 3/017; G06Q 10/06316; G06K 9/00335

(57) ABSTRACT

The present technology relates to an information processing apparatus capable of promoting face-to-face communication, an information processing method, and a program. An information processing apparatus according to one aspect of the present technology identifies a plurality of persons, detects a specific operation performed by the plurality of persons together, and performs processing depending on a combination of the plurality of persons in a case where the specific operation is detected. For example, a task is registered when users in charge of the task perform an operation such as high five or handshake while a task management application is being executed. Also when the task is terminated and completed, the users who perform the task are required to perform the operation such as high five or handshake. The present technology is applicable to a system configured to project a video from a projector and to present information.

### TECHNICAL FIELD

The present technology relates to an information processing apparatus, an information processing method, and a program, and particularly to an information processing apparatus capable of promoting face-to-face communication, an information processing method, and a program.

### BACKGROUND ART

In recent years, there has arisen a problem in which family members have an opportunity to gather but each member uses a Smartphone or the like and conversation among them decreases.

There are various tasks such as domestic works including meal preparation, cleaning, washing, and shopping, or planning to make a travel while family members live, but even who does the tasks may be determined via not face-to-face communication but SNS communication.

Works such as task management may be performed by use of a tool provided by a server on a network in the business.

### CITATION LIST

### Patent Document

Patent Document 1: Japanese Patent Application Laid-Open No. 2005-222246

### SUMMARY OF THE INVENTION

### Problems to be Solved by the Invention

The above tool can be viewed and updated anytime and anywhere, and is efficient and convenient, but face-to-face communication tends to be short.

The present technology has been made in terms of such a situation, and is directed to promoting face-to-face communication.

### Solutions to Problems

An information processing apparatus according to one aspect of the present technology includes an individual identification part configured to identify a plurality of persons, an operation detection part configured to detect a specific operation performed by the plurality of persons together, and a processing control part configured to perform processing depending on a combination of the plurality of persons in a case where the specific operation is detected.

The operation detection part can detect the specific operation performed by the plurality of persons who are close to each other.

The operation detection part can detect an operation performed by the plurality of persons who contact each other as the specific operation.

The operation detection part can detect an operation in which the plurality of persons issues a predetermined word as the specific operation.

The individual identification part can identify the plurality of previously-registered persons on the basis of information detected by a sensor or on the basis of an input operation by the plurality of persons.

In a case where a task to be registered is selected on a management screen used for task management and the specific operation is detected, the processing control part can register the task to be registered as a task performed by the plurality of persons who perform the specific operation in cooperation.

The processing control part can store task information including information indicating contents of registered task, expiration, a person in cooperation, and operation at the end of task.

In a case where it is detected that a person expressed by the task information performs an operation at the end of a task as the specific operation, the processing control part can manage assuming that the task with contents expressed by the task information ends.

The processing control part can control displaying the management screen such that display of the management screen is changed depending on a combination of the plurality of persons in a case where the specific operation is detected.

The processing control part can control displaying the management screen projected by a projection apparatus.

The processing control part can perform processing of unlocking a device to be controlled.

According to one aspect of the present technology, a plurality of persons is identified and a specific operation performed by the plurality of persons together is detected. Further, in a case where the specific operation is detected, processing depending on a combination of the plurality of persons is performed.

### Effects of the Invention

According to the present technology, it is possible to promote face-to-face communication.

Additionally, the effects described herein are not necessarily limited, and may be any effect described in the present disclosure.

### BRIEF DESCRIPTION OF DRAWINGS

FIG. 1 is a diagram illustrating an exemplary use state of an information processing system according to one embodiment of the present technology.

FIG. 2 is a diagram illustrating an exemplary operation of a screen projected on a table.

FIG. 3 is a diagram illustrating an exemplary specific operation.

FIG. 4 is a block diagram illustrating an exemplary hardware configuration of an information processing apparatus.

FIG. 5 is a block diagram illustrating an exemplary functional configuration of the information processing apparatus.

FIG. 6 is a flowchart for explaining basic processing by the information processing apparatus.

FIG. 7 is a diagram illustrating exemplary operations.

FIG. 8 is a diagram illustrating other exemplary operations.

FIG. 9 is a flowchart for explaining task management processing by the information processing apparatus.

FIG. 10 is a diagram illustrating an exemplary data structure of task information and user-associated information.

FIG. 11 is a diagram illustrating an exemplary configuration of a task management screen.

FIG. 12 is a diagram illustrating exemplary screen transitions on task registration.

FIG. 13 is a diagram subsequent to FIG. 12 illustrating exemplary screen transitions on task registration.

FIG. 14 is a diagram illustrating exemplary display of the task management screen.

FIG. 15 is a diagram illustrating exemplary screen transitions on task completion.

FIG. 16 is a diagram subsequent to FIG. 15 illustrating exemplary screen transitions on task completion.

FIG. 17 is a diagram illustrating other exemplary configuration of the information processing system.

FIG. 18 is a diagram illustrating an exemplary circuit configuration.

FIG. 19 is a diagram illustrating an exemplary configuration of the information processing system.

FIG. 20 is a block diagram illustrating an exemplary functional configuration of the information processing apparatus realizing the information processing system of FIG. 19.

FIG. 21 is a flowchart for explaining device control processing by the information processing apparatus.

FIG. 22 is a diagram illustrating an exemplary data structure of limitation information.

FIG. 23 is a diagram illustrating exemplary communication in a virtual space.

FIG. 24 is a block diagram illustrating an exemplary configuration of a computer.

### MODE FOR CARRYING OUT THE INVENTION

Modes for carrying out the present technology will be described below. The description will be made in the following order.

1. Basic system configuration assumed

2. Flow of basic processing

3. Application of information processing system (application to task management)

4. Application of information processing system (application to parental lock)

5. Effects and variants

### 1. Basic System Configuration Assumed

### <<1.1 Exemplary Use State>>

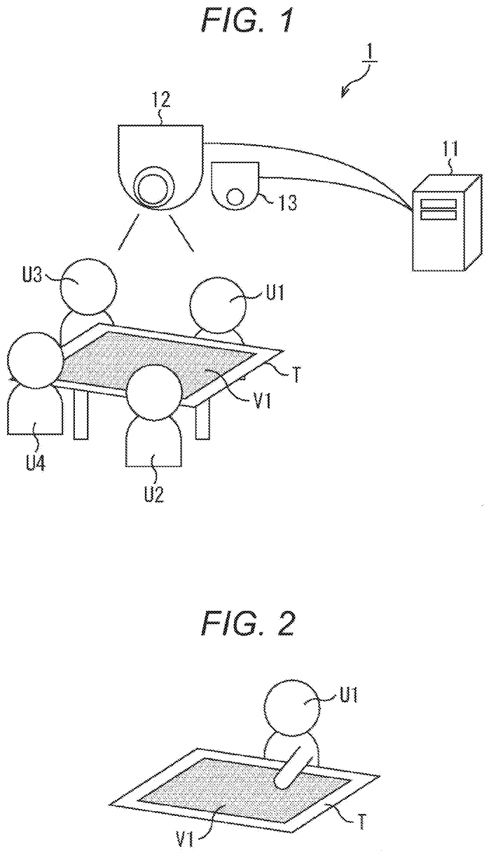

FIG. 1 is a diagram illustrating an exemplary use state of an information processing system according to one embodiment of the present technology.

An information processing system 1 of FIG. 1 is used by family members in a room in a house, for example. The information processing system 1 is used to project a video and to present information. In the example of FIG. 1, a top surface of a table T placed in a room is used as a projection plane of a video. It is assumed that users U1 to U4 as family members are seated around the table T.

As illustrated in FIG. 1, the information processing system 1 is configured of an information processing apparatus 11, a video display apparatus 12, and a sensor apparatus 13.

In the example of FIG. 1, the video display apparatus 12 as a projector is installed near the ceiling in the room with the light irradiation direction toward the table T. The video display apparatus 12 projects a predetermined video V1 such as a screen of an application executed by the information processing apparatus 11 on the table T under control of the information processing apparatus 11.

The sensor apparatus 13 is installed to be able to detect a situation of the range including the projection plane of the video display apparatus 12. In the example of FIG. 1, the sensor apparatus 13 is installed near the video display apparatus 12. The sensor apparatus 13 is a depth sensor mounting a binocular camera, an infrared depth sensor, or the like, for example, thereon capable of acquiring a 3D image. The shapes of respective objects including person, the distances to each object, and the like are expressed by a 3D image.

The sensor apparatus 13 transmits depth information indicating the shape or distance of each object expressed by a 3D image as sensor data to the information processing apparatus 11. The sensor data transmitted from the sensor apparatus 13 is used to detect a person, to detect an operation, and the like.

A user reaches onto the table T and contacts an icon, a button, or the like configuring the screen as illustrated in FIG. 2, for example, so that the screen projected on the table T is operated. The sensor data transmitted by the sensor apparatus 13 is used to detect a user operation on the screen projected on the table T as described above, or the like.

Information is exchanged between the information processing apparatus 11 and the video display apparatus 12, and between the information processing apparatus 11 and the sensor apparatus 13, which are installed at predetermined positions in a room, via wired communication or via wireless communication in a predetermined standard such as wireless local area network (LAN) or Bluetooth (registered trademark).

The information processing apparatus 11 detects a person in the detection range on the basis of the sensor data transmitted from the sensor apparatus 13, and then identifies the detected person with reference to person registration information. Further, the information processing apparatus 11 determines whether or not the identified person has performed a specific operation with reference to operation registration information. The information processing apparatus 11 determines processing contents depending on a determination result as to “who has performed what operation”, and performs the determined processing.

In the information processing system 1 having such a configuration, there is realized a system for performing processing when persons face each other and perform a specific operation together.

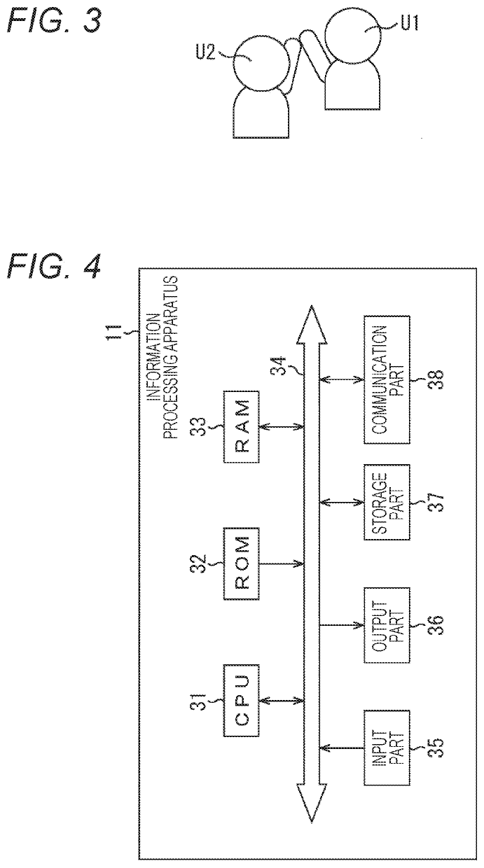

That is, the users U1 to U4 as users of the information processing system 1 perform a specific operation such as high five as illustrated in FIG. 3 thereby to use the function of an application. In the example of FIG. 3, the user U1 and user U2 raise the right hand and do high fives.

In the information processing system 1, predetermined processing is performed in response to a determination result indicating that the users who have done high fives are the user U1 and the user U2 and high five has been done as a specific operation to be performed together.

In this way, the information processing system 1 is configured as a system which does not operate if persons of interest are not in the same space, thereby promoting face-to-face communication. Further, the users need to perform a specific operation together in order to use the function of an application, and thus the respective users feel a sense of achievement or a sense of cooperation, thereby promoting teamwork.

Additionally, in the example of FIG. 1, the video display apparatus 12 as a projector is provided as a device for presenting information, but a table-shaped display with a large-sized display provided on the top may be provided for the video display apparatus 12.

Further, a user's motion is assumed to be detected on the basis of an output of the sensor apparatus 13 as a depth sensor, but may be detected on the basis of an output of a user's worn sensor, or may be detected on the basis of an output of a sensor installed on the table T.

The information processing system 1 may be used in buildings other than private houses, such as public institutions, or may be used outdoors. Further, not the top surface of a table but various planes capable of detecting a user operation, such as wall or floor, may be used for the projection plane of the video display apparatus 12. Not flat planes but various planes such as surface of an automobile or surface of a chair may be used as a projection plane. The positions where the video display apparatus 12 and the sensor apparatus 13 are installed are changed as needed depending on a position of the projection plane.

The functions of the video display apparatus 12 are mounted on the sensor apparatus 13, and the functions of the video display apparatus 12 and the functions of the sensor apparatus 13 may be realized in one apparatus.

### <<1.2 Exemplary Configuration of Each Apparatus>>

FIG. 4 is a block diagram illustrating an exemplary hardware configuration of the information processing apparatus 11.

As illustrated in FIG. 4, the information processing apparatus 11 is configured such that a CPU 31, a ROM 32, a RAM 33, an input part 35, an output part 36, a storage part 37, and a communication part 38 are connected via a bus 34.

The central processing unit (CPU) 31 executes programs stored in the read only memory (ROM) 32 on the random access memory (RAM) 33, and controls the operations of the entire information processing apparatus 11, for example.

The input part 35 includes a keyboard, a mouse, and the like, and receives user operations of the information processing system 1.

The output part 36 is configured of a display, a speaker, or the like (not illustrated). Data indicating a screen of an application may be output not from the communication part 38 but from the output part 36. In this case, the output part 36 functions as an interface for outputting video data of the screen.

The storage part 37 is configured of a hard disc, a flash memory, or the like. The storage part 37 stores therein various items of information such as the programs executed by the CPU 31.

The communication part 38 makes wired or wireless communication with the video display apparatus 12 and the sensor apparatus 13. For example, the communication part 38 receives sensor data transmitted from the sensor apparatus 13. Further, the communication part 38 transmits data indicating a screen of an application to the video display apparatus 12. The communication part 38 makes communication with an external device via the Internet as needed.

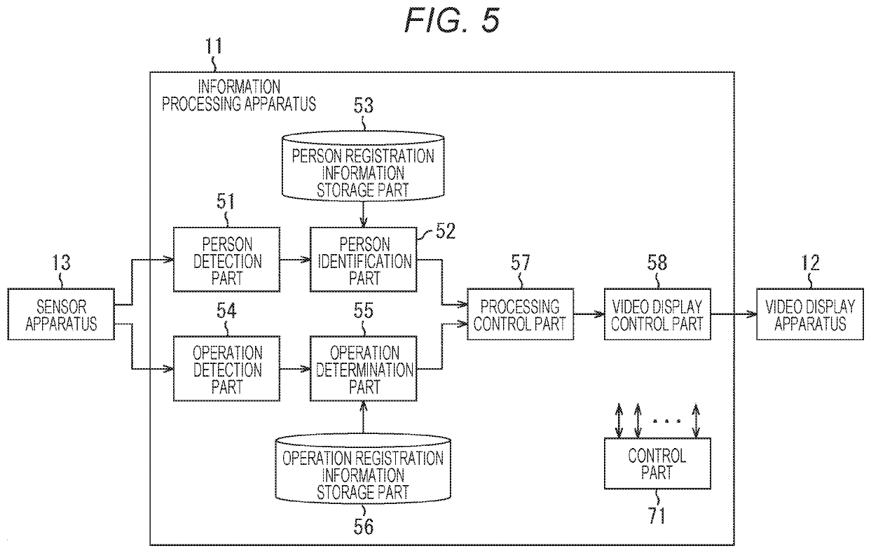

FIG. 5 is a block diagram illustrating an exemplary functional configuration of the information processing apparatus 11. Predetermined programs are executed by the CPU 31 of FIG. 4 so that at least some of the function parts of the information processing apparatus 11 illustrated in FIG. 5 are realized.

As illustrated in FIG. 5, a person detection part 51, a person identification part 52, a person registration information storage part 53, an operation detection part 54, an operation determination part 55, an operation registration information storage part 56, a processing control part 57, a video display control part 58, and a control part 71 are realized in the information processing apparatus 11. The sensor data transmitted from the sensor apparatus 13 and received by the communication part 38 is input into the person detection part 51 and the operation detection part 54.

The person detection part 51 detects a user around the table T on the basis of the depth information input as sensor data. For example, a user is detected on the basis of the shapes of human body's sites such as head, pieces, and arms expressed by the depth information. The person detection part 51 outputs the information indicating the position of each detected user to the person identification part 52. The sensor data is also supplied to the person identification part 52.

The person identification part 52 identifies the user detected by the person detection part 51 with reference to the person registration information stored in the person registration information storage part 53. For example, the user is identified on the basis of the physical characteristics such as height and shoulder length expressed by the depth information. In this case, the person registration information storage part 53 stores therein the information indicating the physical characteristics of each user as person registration information. The person identification part 52 outputs identification information indicating who the user is around the table T to the processing control part 57.

The person registration information storage part 53 stores person registration information of each user using the information processing system 1. Each user using the information processing system 1 needs to register the person registration information indicating his/her physical characteristics in the information processing apparatus 11 at a predetermined timing such as on initial registration. The person registration information is registered on the basis of the depth information or the like detected on initial registration, for example.

The operation detection part 54 detects an operation of the user around the table T on the basis of the time series of the depth information input as sensor data. For example, an operation of the user is detected by recognizing a hand of the person on the basis of the depth information, and tracking the position of the recognized hand. The operation detection part 54 outputs the information indicating what operation the user is performing to the operation determination part 55.

The operation determination part 55 determines whether or not a specific operation has been performed by the user with reference to the operation registration information stored in the operation registration information storage part 56. For example, the operation registration information storage part 56 stores therein the information indicating a temporal change in position of the hand, such as high five or handshake, when a plurality of users performs a specific operation together as operation registration information. In a case where the operation determination part 55 determines that a specific operation has been performed, it outputs the identification information indicating the operation which the user has performed to the processing control part 57.

The operation registration information storage part 56 stores operation registration information. The operation registration information storage part 56 stores therein the operation registration information used for determining a plurality of operations, for example.

The processing control part 57 recognizes which user has performed a specific operation around the table T on the basis of the user identification information supplied from the person identification part 52 and the operation identification information supplied from the operation determination part 55. The processing control part 57 determines processing contents to be performed on the basis of a combination of users who have performed the specific operation.

The processing control part 57 performs processing depending on a combination of users who have performed the specific operation. The processing control part 57 controls the video display control part 58 and reflects the processing result on the screen display as needed.

The video display control part 58 updates the screen being displayed on the basis of the information supplied from the processing control part 57, and transmits video data of the updated screen to the video display apparatus 12. The video display apparatus 12 displays the screen on the basis of the video data supplied from the video display control part 58.

The control part 71 performs various pieces of processing for detecting a user input operation on the information processing apparatus 11, and the like.

### 2. Flow of Basic Processing

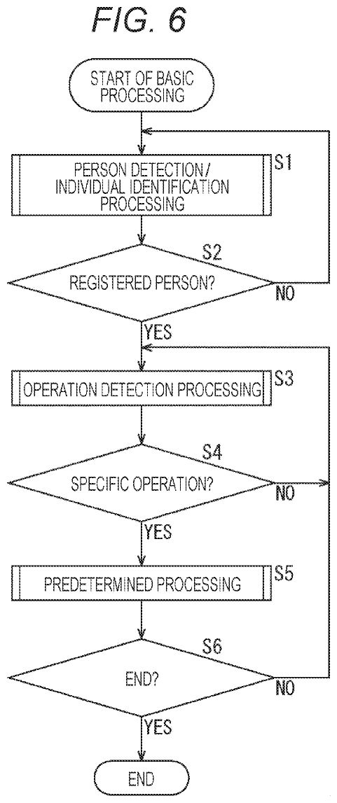

Basic processing of the information processing apparatus 11 with the above configuration will be described herein with reference to the flowchart of FIG. 6.

Before starting the processing of FIG. 6, a user registration processing is performed, and information indicating physical characteristics of each user is stored as person registration information in the person registration information storage part 53 on the basis of the sensor data output from the sensor apparatus 13.

In step S1, person detection/individual identification processing is performed. A user who is detected as present around the table T is identified on the basis of the depth information input as sensor data in the person detection/individual identification processing.

In step S2, the person identification part 52 determines whether or not the identified user is a registered person. In a case where it is determined in step S2 that the identified user is not a registered person, the processing returns to step S1 and the above processing is repeatedly performed.

On the other hand, in a case where it is determined in step S2 that the identified user is a registered person, the processing proceeds to step S3. The identification information indicating the user who is determined as a registered person is supplied to the processing control part 57.

In step S3, operation detection processing is performed. An operation of each user is detected on the basis of the depth information input as sensor data in the operation detection processing.

In step S4, the operation determination part 55 determines whether or not a specific operation has been performed by the user. In a case where it is determined in step S4 that the specific operation has not been performed, the processing returns to step S3 and the above processing is repeatedly performed.

On the other hand, in a case where it is determined in step S4 that the specific operation has been performed, the processing proceeds to step S5. The identification information indicating the operation performed by the user is supplied to the processing control part 57.

In step S5, predetermined processing is performed on the basis of a combination of users who have performed the specific operation. That is, the processing control part 57 performs the processing depending on which users have performed high fives or the like. The processing is performed thereby to update the application screen display, or the like.

In step S6, the processing control part 57 determines whether or not to terminate the processing. In a case where it is determined in step S6 that the processing is not to be terminated, the processing returns to step S3 and the above processing is repeatedly performed. On the other hand, in a case where it is determined in step S6 that the processing is to be terminated in response to an instruction to terminate the application, for example, the processing is terminated.

The basic processing as described above are performed also when a predetermined application is executed. When an application is executed, various pieces of processing other than the pieces of processing in the respective steps illustrated in FIG. 6 are performed.

The person detection/individual identification processing performed in step S1 and the operation detection processing performed in step S3 will be described below in detail.

### <<2.1 Person Detection/Individual Identification Processing>>

### <2.1.1 Person Detection>

The person detection in step S1 is performed by the person detection part 51 on the basis of the depth information indicating a situation around the table T including the top of the table T detected by the sensor apparatus 13.

In a case where the sensor apparatus 13 has a camera including a situation around the table Tin the shooting range, the user detection may be performed by analyzing an image shot by the camera. For example, a characteristic site of the face is detected by analyzing an image, and whether or not a user is present around the table T is determined on the basis of the detection result.

A 360-degree camera or a plurality of cameras is installed at the center of the table T, for example, and the user detection may be performed by use of the images shot by the cameras.

Further, pressure sensors are installed on the seats of the chairs placed around the table T, and the user detection may be performed on the basis of the temporal changes in the sensor values.

A plurality of the detection units may be integrated thereby to perform the user detection. Thereby, the user detection accuracy can be improved.

### <2.1.2 Individual Identification>

The individual identification in step S1 is performed by the person identification part 52 on the basis of the physical characteristics such as height and shoulder length expressed by the depth information detected by the sensor apparatus 13.

In a case where the sensor apparatus 13 has a camera as described above, the user identification may be performed by analyzing the images shot by the camera. For example, the characteristic amount of a site of the face is detected by analyzing the images and the detection result is compared with the previously-registered characteristic amount thereby to identify the user. In this case, the information indicating the characteristic amounts of the faces of the respective users is registered as person registration information in the person registration information storage part 53.

Further, in a case where a pressure sensor is provided on the seat of a chair as described above, the user identification may be performed on the basis of the sensor value (weight) detected by the pressure sensor. In this case, the information indicating the weights of the respective users is registered as person registration information in the person registration information storage part 53.

A screen (user interface (UI)) used for selecting who is where may be displayed by the video display apparatus 12 and actively selected by each user before starting to use the information processing system 1, thereby identifying the user.

In a case where the sensor apparatus 13 has a speech input device (microphone) for collecting sounds around the table T, speech recognition is performed on the speech detected by the microphone, and the user may be detected and identified. Each user may be caused to say his/her name like “I am ∘∘” before starting to use the information processing system 1. In this case, the speech data transmitted from the sensor apparatus 13 is supplied to the person identification part 52 to be used for the speech recognition.

Further, communication may be made between the information processing apparatus 11 and a portable terminal such as Smartphone of each user (between an application executed by the information processing apparatus 11 and a portable terminal), and the user may be detected and identified on the basis of the information transmitted from the portable terminal to the information processing apparatus 11. In this case, the identification information or the like used by each user is registered as person registration information in the person registration information storage part 53. Information in which the account information of an SNS service is associated with an application may be compiled in a database and registered in the person registration information storage part 53.

An application executed by the information processing apparatus 11 may manage the user information such as account name or password, and the user may be detected and identified on the basis of the user-input information on log-in.

A plurality of the identification units may be integrated thereby to perform the user identification. Thereby, the user identification accuracy can be improved.

### <2.2 Operation Detection Processing>

The operation detection in step S3 is performed by the operation detection part 54 by recognizing person's hands and tracking their positions on the basis of the time series of the depth information. For example, high five is detected by determining whether or not a plurality of users has slapped their hands at a high position.

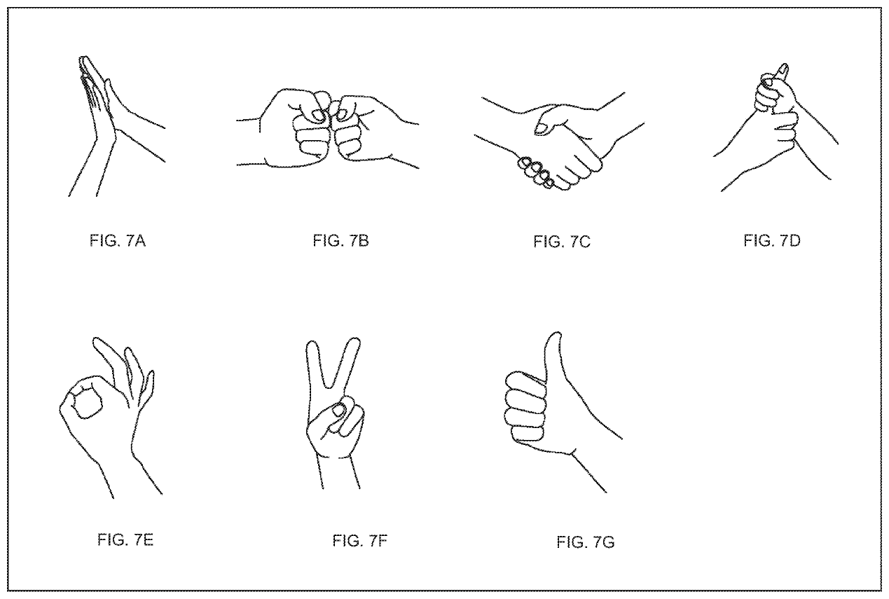

FIG. 7 is a diagram illustrating exemplary operations detected by the operation detection part 54.

There are detected operations in which hands contact each other, for example, each other's fists are contacted, or first bump (B of FIG. 7), and a raised finger of one user is gripped by the other user, or follow me (D of FIG. 7) in addition to high five illustrated in A of FIG. 7 or handshake illustrated in C of FIG. 7.

There may be detected operations in which each other's hands do not contact, such as OK sign (E of FIG. 7), peace sign (F of FIG. 7), and thumbs-up (G of FIG. 7). Predetermined processing may be performed when a plurality of users performs such a non-contact operation together. For example, OK sign performed face-to-face at the same time is also face-to-face communication.

There may be detected other operations such as putting his/her hand up, pumping his/her fist, or a plurality of users' overlapping their hands.

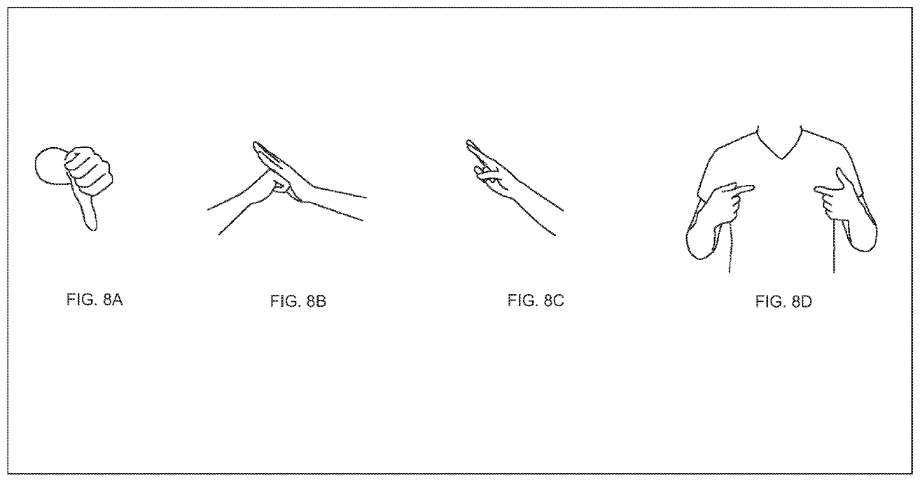

The meanings of the operations such as gestures are different depending on the country or region. The operations according to the culture of a country or region where the information processing system 1 is used may be detected. For example, the operations as illustrated in A to C of FIG. 8 may be detected in Chine. Further, the operations illustrated in C of FIG. 8 and D of FIG. 8 may be detected in the U.S.

Further, an operation on the screen displayed on the table T may be detected. In this case, a distance between the surface of the table T and a hand is detected on the basis of the depth information, and whether a plurality of users has touched (contacted) a predetermined portion together, or the like is determined.

In a case where the sensor apparatus 13 has a microphone for collecting sounds around the table T, an operation of is suing a watchword may be detected. In this case, the speech data transmitted from the sensor apparatus 13 is supplied to the operation detection part 54, for example, and speech recognition is performed. The operation determination part 55 determines whether or not a predetermined watchword has been issued on the basis of the speech recognition result, and outputs the identification information indicating the contents to the processing control part 57 in a case of determining that the predetermined watchword has been issued.

A combined operation of the operation of issuing a watchword and the operation such as high five may be detected. Thereby, wider variations of the operations can be achieved.

Further, communication is made between the information processing apparatus 11 and a portable terminal of each user, and the operation on the screen displayed on the portable terminal may be detected as a user operation by the operation detection part 54. In this case, when a predetermined button or the like is displayed on the screen of the portable terminal and the button is operated, the information indicating the fact is transmitted to the information processing apparatus 11.

A plurality of the detection units may be integrated thereby to detect a user operation. Thereby, the user operation detection accuracy can be improved.

### 3. Applications of Information Processing System (Application to Task Management)

The description will be made herein assuming that the information processing system 1 is applied to a system for executing a task management application as an application for managing tasks. Task (ToDo) indicates things to do, things to remember, or the like.

The information processing system 1 realized when the information processing apparatus 11 executes the task management application is used by family members, and communication between the family members can be promoted via the task management.

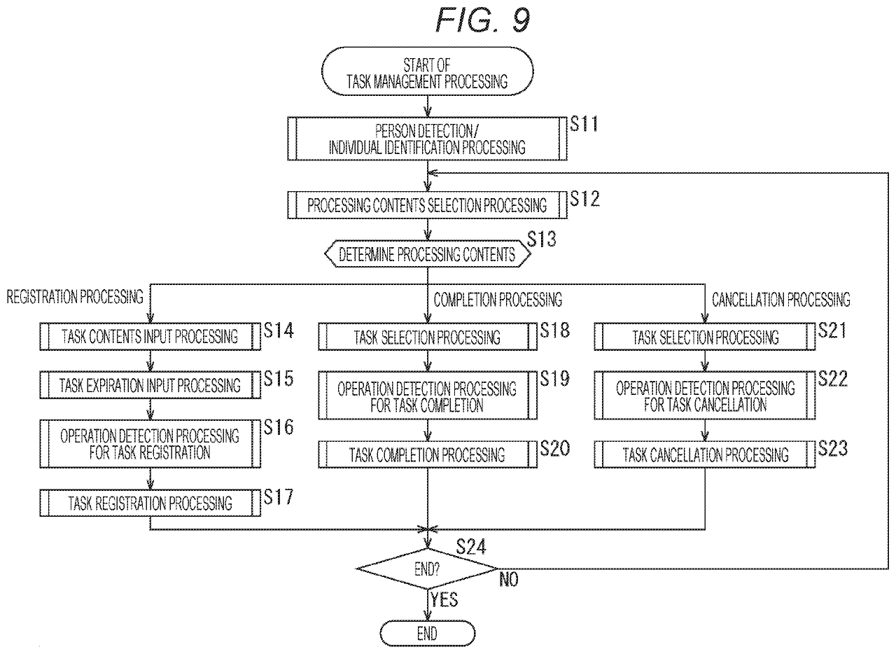

Task management processing of the information processing apparatus 11 for executing the task management application will be described with reference to the flowchart of FIG. 9.

In step S11, person detection/individual identification processing is performed. The person detection/individual identification processing performed in step S11 corresponds to the processing in step S1 in FIG. 6.

That is, a user present around the table T is detected and the detected user is identified on the basis of the depth information input as sensor data. The person identification information for identifying the respective users configuring the family is stored in the person registration information storage part 53.

In a case where all the users registered as family members are identified, the pieces of processing in and subsequent to step S12 are performed. The respective pieces of processing in and subsequent to step S12 will be described below in detail as needed.

In step S12, processing contents selection processing is performed. Task registration processing, task completion processing, and task cancellation processing are prepared for the task management processing, for example.

The task registration processing is performed for registering a new task. The task completion processing is performed for completing a registered task. The task cancellation processing is performed for canceling a registered task.

In step S13, the control part 71 determines the contents of the selected processing. In a case where it is determined in step S13 that the task registration processing has been selected, the processing proceeds to step S14.

In step S14, task contents input processing is performed.

In a case where task contents are input, in step S15, task expiration input processing is performed.

In a case where a task expiration is input, in step S16, operation detection processing for task registration is performed.

In a case where it is detected that the user has performed the operation for task registration, in step S17, task registration processing is performed.

On the other hand, in a case where it is determined in step S13 that the task completion processing has been selected, the processing proceeds to step S18.

In step S18, processing of selecting a task to be completed is performed.

In a case where a task to be completed is selected, in step S19, operation detection processing for task completion is performed.

In a case where it is detected that the user has performed the operation for task completion, in step S20, task completion processing is performed.

On the other hand, in a case where it is determined in step S13 that the task cancellation processing has been selected, the processing proceeds to step S21.

In step S21, processing of selecting a task to be canceled is performed.

In a case where a task to be canceled is selected, in step S22, operation detection processing for task cancellation is performed.

In a case where it is detected that the user has performed the operation for task cancellation, in step S23, task cancellation processing is performed.

In a case where the task registration processing in step S17, the task completion processing in step S20, or the task cancellation processing in step S23 is performed, in step S24, a determination is made as to whether or not to terminate the processing.

In a case where it is determined in step S24 that the processing is not to be terminated, the processing returns to step S12 and the above processing is repeatedly performed. On the other hand, in a case where it is determined that the processing is to be terminated, the execution of the task management application is terminated and the processing ends.

### <<3.1 Processing Contents Selection Processing>>

The processing contents selection in step S12 is performed by use of a task management screen projected on the table T. The buttons used for selecting the respective pieces of processing are displayed on the task management screen.

All the family members place their hand on or touch a button displayed on the task management screen so that processing contents are selected. The user operation on the button displayed on the task management screen is detected by the operation detection part 54, for example.

Processing contents may be selected by speech. In this case, the user issues words indicating the processing contents, such as “register task”, “complete task”, “cancel task”, or the like. For example, the operation detection part 54 performs speech recognition on the speech detected by the microphone. The control part 71 acquires the speech recognition result by the operation detection part 54 and receives the user's selection.

In a case where the history information indicating the tasks registered in the past is held, contents of a task to be registered may be selected on the basis of the history information, and may be given in notification to the user under control of the control part 71. For example, in a case where a periodical task such as “water the garden once a week” registered every week is not registered, the fact is given in notification, and when the user operates for the notification, the task registration processing is selected.

A periodical task is given in notification by outputting speech from a speech apparatus (speaker) or displaying the information indicating the notification contents on the task management screen, for example. The fact that a close-to-date task is present may be given in notification to the user.

### <<3.2 Task Registration Processing>>

### <3.2.1 Task Contents Input Processing>

The task contents input in step S14 is performed by use of the task management screen projected on the table T. Buttons and the like for inputting characters are displayed on the task management screen. In a case where the operation detection part 54 detects that the buttons and the like have been operated, the control part 71 receives the task contents input in response to the user operation.

The task contents input may be performed by speech. Further, task contents may be input by an operation on the mask or keyboard configuring the input part 35.

### <3.2.2 Task Expiration Input Processing>

The task expiration input in step S15 is performed by use of the task management screen projected on the table T. A calendar is displayed on the task management screen, for example. In a case where an operation on the calendar is detected by the operation detection part 54, the control part 71 receives the task expiration input to set the user-selected date as expiration.

The task expiration input may be performed by speech.

The information indicating the input task expiration may be transmitted to the portable terminal of the user, and may be automatically reflected on the schedule information managed by various applications such as calendar application installed in the portable terminal.

### <3.2.3 Operation Detection Processing for Task Registration>

Which user has performed the previously-determined operation for task registration is detected in the operation detection processing for task registration performed in step S16. In this example, a user who has performed the operation for task registration is set as a person in charge of the task.

The operation detection processing for task registration performed in step S16 corresponds to the processing in step S3 in FIG. 6. That is, the processing similar to the processing described in 2.2 is performed and the user operation is detected by the operation detection part 54. Further, whether or not the detected operation is the operation for task registration is determined by the operation determination part 55, and the determination result is output to the processing control part 57.

The processing control part 57 specifies the user who has performed the operation for task registration on the basis of the identification result by the person identification part 52, and sets the specified user as a person in charge of the task. For example, the users who have done high fives and contacted each other are set as persons in charge of the task. The tasks performed by a plurality of users in cooperation are managed in the information processing system 1.

### <3.2.4 Task Registration Processing>

Task information is generated and managed by the processing control part 57 in the task registration processing performed in step S17. The task information is stored and managed in the storage part 37. A data structure of the task information will be described below.

In this way, a plurality of users who have performed the operation for task registration is set and registered as persons in charge of the task on the task registration processing. Further, the information indicating that the users are set as persons in charge is displayed on the task management screen as needed.

The processing of registering a user who has performed the operation for task registration as a person in charge of the task and displaying the task management screen in response to the operation for task registration corresponds to the processing performed in step S5 in FIG. 6. These pieces of processing change in their contents depending on a combination of users who have performed the operation for task registration.

After the task registration processing is performed, the processing proceeds to step S24 and the subsequent pieces of processing are performed.

### <<3.3 Task Completion Processing>>

### <3.3.1 Task Selection Processing>

The task selection in step S18 is performed by use of the task management screen projected on the table T. The information such as icons (images) or characters indicating the registered tasks is displayed on the task management screen. In a case where the operation detection part 54 detects that the icons or the like have been operated, the control part 71 receives the task selection to complete the user-selected task.

A task to be completed may be selected by speech.

### <3.3.2 Operation Detection Processing for Task Completion>

Which user has performed the predetermined operation for task completion is detected in the operation detection processing for task completion performed in step S19. In this example, the users who have performed the task need to perform the operation for task completion together in order to complete the task.

The operation detection processing for task completion performed in step S19 corresponds to the processing in step S3 in FIG. 6. That is, the processing similar to the processing described in 2.2 is performed and the user operation is detected by the operation detection part 54. Further, whether or not the detected operation is the operation for task completion is determined by the operation determination part 55, and the determination result is output to the processing control part 57.

The processing control part 57 specifies the user who has performed the operation for task completion on the basis of the identification result by the person identification part 52, and determines whether or not the specified user matches with the user set as a person in charge of the task. For example, in a case where the operation for task completion is high five, and the users who have done high fives and contacted each other are set as persons in charge of the task, the processing control part 57 determines that the users who have performed the operation for task completion match with the users set as persons in charge.

In a case where the users who have performed the operation for task completion do not match with the users set as persons in charge, the processing control part 57 does not perform the processing or feeds back the error. The feedback of error is performed by controlling the video display apparatus 12 and causing it to display the information indicating the fact, or by speech, for example.

### <3.3.3 Task Completion Processing>

The task completion processing in step S20 is performed in a case where it is determined that the user who has performed the operation for task completion matches with the user set as a person in charge of the task. The processing control part 57 updates the task information to delete the selected task to be completed in the task completion processing.

In a case where all the tasks are completed, an effect image indicating the fact may be displayed on the task management screen.

In a case where a task remains after the task information is updated, the processing returns to the task selection processing (step S18) again and the above processing may be repeatedly performed. Further, after the task information is updated, the processing may proceed to the task input processing (step S14), or in a case where an uncompleted task/expired task is present, the processing may proceed to the task expiration input processing (step S15).

In this way, the processing of completing the task of which the user who has performed the operation for task completion is in charge is performed on the task completion processing. Further, the information indicating that the task is completed is displayed on the task management screen as needed.

The processing of updating the task information of the user who has performed the operation for task completion and displaying the task management screen in response to the operation for task completion corresponds to the processing performed in step S5 in FIG. 6. These pieces of processing change in their contents depending on a combination of users who have performed the operation for task completion.

### <<3.4 Task Cancellation Processing>>

### <3.4.1 Task Selection Processing>

The task selection in step S21 is performed by use of the task management screen projected on the table T. The information such as icons or characters indicating the registered tasks is displayed on the task management screen. In a case where the operation detection part 54 detects that the icons and the like have been operated, the control part 71 receives the task selection to cancel the user-selected task.

A task to be canceled may be selected by speech.

### <3.4.2 Task Cancellation Operation>

Which user has performed the predetermined operation for task cancellation is detected in the operation detection processing for task cancellation performed in step S22. In this example, the user who cancels the task needs to perform the operation for task cancellation in order to cancel the task.

The operation detection processing for task completion performed in step S22 corresponds to the processing in step S3 in FIG. 6. That is, the processing similar to the processing described in 2.2 is performed and the user operation is detected by the operation detection part 54. Further, whether or not the detected operation is the operation for task cancellation is determined by the operation determination part 55, and the determination result is output to the processing control part 57.

The processing control part 57 specifies the user who has performed the operation for task cancellation on the basis of the identification result by the person identification part 52, and determines whether or not the specified user matches with the user set as a person in charge of the task.

The operation for task cancellation can be assumed as an operation of moving the icon indicating the task to be canceled to the trash box displayed on the task management screen. In a case where the user who has performed the operation of moving the icon is specified as a person in charge of the task, the processing control part 57 determines that the user who has performed the operation for task cancellation matches with the user set as a person in charge.

The operation for task cancellation may use an operation of issuing a predetermined word. For example, the task cancellation can be made by the operation of issuing the words “to trash box” after issuing the task name.

In a case where the user who has performed the operation for task cancellation does not match with the user set as a person in charge, the processing control part 57 does not perform the processing or feeds back the error. The feedback of error is performed by controlling the video display apparatus 12 and causing it to display the information indicating the fact, or by speech, for example.

### <3.4.3 Task Cancellation Processing>

The task cancellation processing in step S23 is performed in a case where it is determined that the user who has performed the operation for task cancellation matches with the user set as a person in charge of the task. The processing control part 57 updates the task information to delete the selected task to be canceled in the task cancellation processing.

In a case where a task remains after the task information is updated, the processing returns to the task selection processing (step S21) again and the above processing may be repeatedly performed. In a case where all the tasks are canceled, the processing may proceed to the task input processing (step S14).

In this way, the processing of canceling the task of which the user who has performed the operation for task cancellation is in charge is performed on the task cancellation processing. Further, the displayed task management screen is updated as needed to indicate that the task has been canceled.

The processing of updating the task information of the user who has performed the operation for task cancellation and displaying the task management screen when the operation for task cancellation is performed corresponds to the processing performed in step S5 in FIG. 6. These pieces of processing change in their contents depending on a combination of users who have performed the operation for task cancellation.

### <<3.5 Data Structure>>

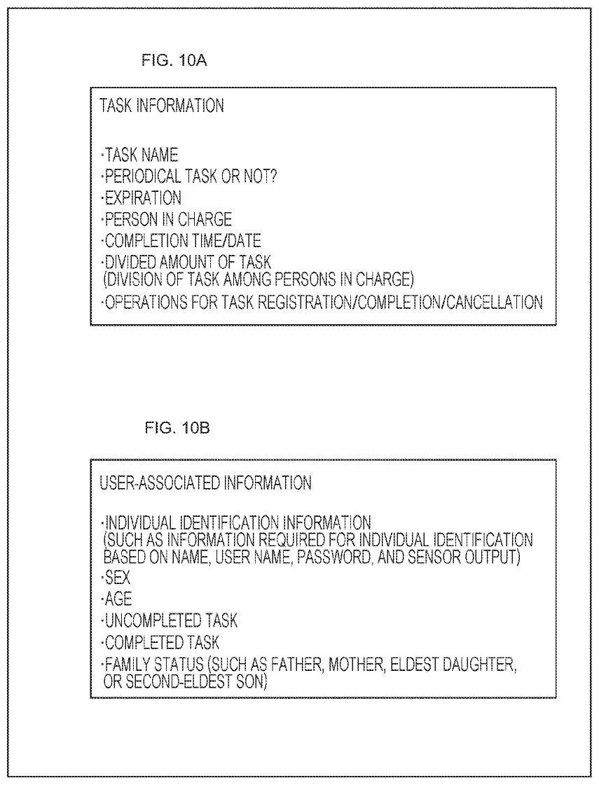

FIG. 10 is a diagram illustrating an exemplary data structure of the task information and the user-associated information.

As illustrated in A of FIG. 10, the task information includes information indicating task name, periodical task or not, expiration, person in charge, completion time/date, divided amount of task, and respective operations for task registration/task completion/task cancellation. The respective operations for task registration/task completion/task cancellation are associated and managed per task. Additionally, the divided amount of task indicates a division of a task among persons in charge, and is input by the user by use of the task management screen.

The task information is generated in the task registration processing, and is managed by the processing control part 57 in association with the user-associated information.

As illustrated in B of FIG. 10, the user-associated information includes information indicating individual identification information, sex, age, uncompleted task, completed task, and family status. The individual identification information is characteristic information or the like required for making individual identification on the basis of name, user name, password, and sensor data detected by the sensor apparatus 13. Further, the family status indicates a relationship in a family such as father, mother, eldest daughter, or second-eldest son.

The user-associated information including each item of such information is stored in the storage part 37 and managed by the control part 71. The characteristic information in the individual identification information included in the user-associated information is stored as person registration information in the person registration information storage part 53.

### <<3.6 Other Functions>>

### <3.6.1 Function of Allocating Operation Per Processing Contents>

An operation for performing the task registration processing, an operation for performing the task completion processing, and an operation for performing the task cancellation processing can be set, respectively, at a predetermined timing such as on the initial setting of the task management application.

For example, an operation for processing contents is allocated such as allocating an operation of pinky-swearing as an operation for performing the task registration processing, and thus the user can intuitively start the task registration processing. Pinky-swearing is an operation used for making a promise in Japan, and can be regarded as an operation for task registration.

Similarly, a high-five operation may be allocated as an operation for performing the task completion processing, and an operation of crossing both hands to make a cross may be allocated as an operation for performing the task cancellation processing.

An operation may be allocated depending on the number of persons in charge. For example, an operation such as handshake performed by two persons together is allocated to processing of a task by two persons in charge. Further, an operation capable of being performed by a plurality of persons together, such as high five or OK sign, is allocated to processing of a task by three or more persons.

### <3.6.2 Operation Customization>

A trigger operation of each processing may be previously set as initial data, or may be registered by a user at a predetermined timing such as on initial setting in a case where the task management application has a function of registering an operation.

When registering an operation, the user performs an operation to be registered in a range in which the sensor apparatus 13 can sense. The operation detection part 54 detects an operation on the basis of the sensor data transmitted from the sensor apparatus 13, and the data of the detected operation is stored in the operation registration information storage part 56, and thus the detected operation is registered as a trigger operation of processing.

A server for managing the operation data registered by each user may be prepared and the operation data may be downloaded from the server via the Internet.

### <3.6.3 Function of Changing Person in Charge>

A user set as a person in charge and a user not as a person in charge perform a predetermined operation thereby to change the persons in charge. For example, in a case where the processing control part 57 determines that a user in charge and a user not in charge perform a predetermined operation such as handshake, it updates the task information to switch the user in charge and the user not in charge.

In this way, face-to-face communication can be required for various pieces of processing such as changing the persons in charge.

### <3.6.4 Task Proposal Function>

The user-associated information managed by the information processing system 1 provided at each house is utilized on a server on the Internet, and a task may be proposed under control of the server. Thereby, a task registered in one family can be proposed to other family.

### <<3.7 Exemplary UI Expression on Task Management>>

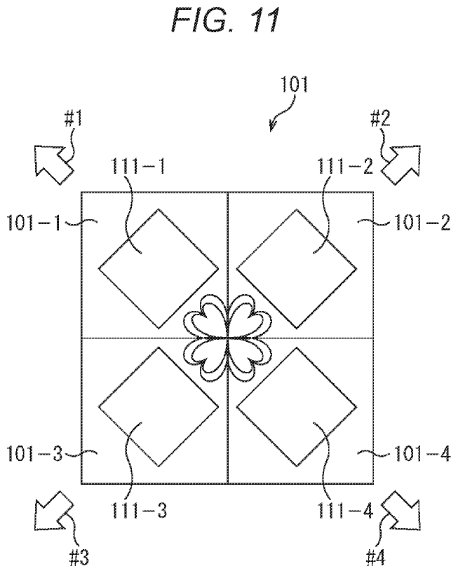

FIG. 11 is a diagram illustrating an exemplary configuration of the task management screen.

As illustrated in FIG. 11, a task management screen 101 is a substantially square screen, and is configured of four substantially-square operation regions 101-1 to 101-4 . The operation region 101-1 is a region for the user U1 seated in the arrow #1 direction, for example, and the operation region 101-2 is a region for the user U2 seated in the arrow #2 direction, for example. The operation region 101-3 is a region for the user U3 seated in the arrow #3 direction, for example, and the operation region 101-4 is a region for the user U4 seated in the arrow #4 direction, for example.

Rhombic arrangement regions 111-1 to 111-4 are displayed in the operation regions 101-1 to 101-4, respectively. In the example of FIG. 11, nothing is displayed in the arrangement regions 111-1 to 111-4, but an image indicating a task, or the like is arranged depending on a user operation.

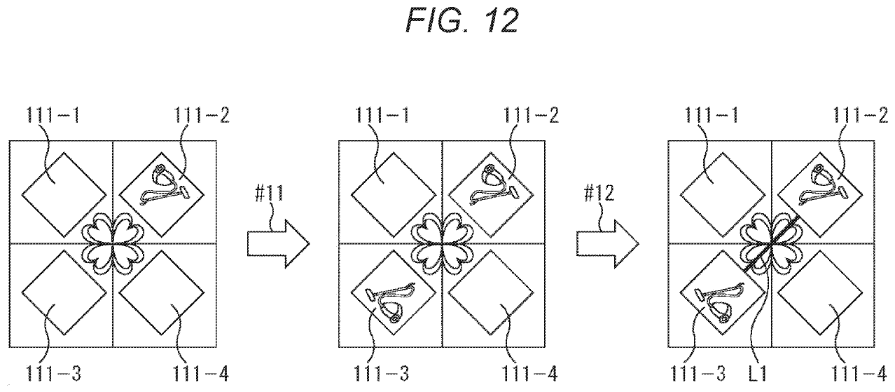

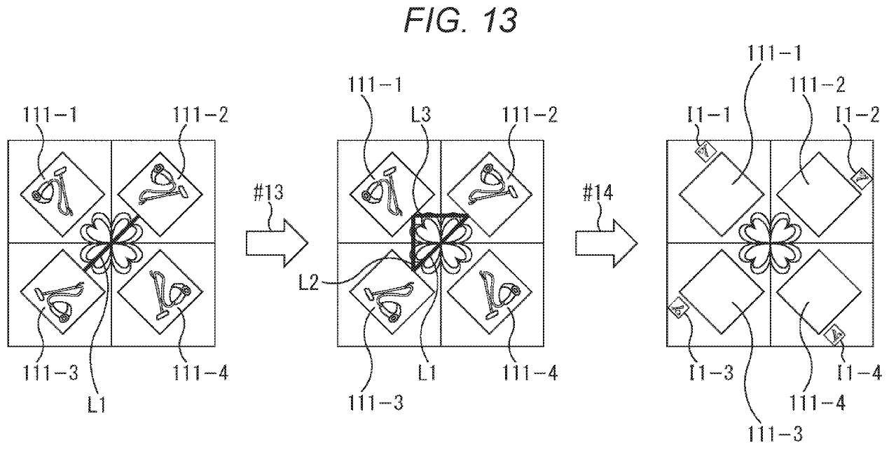

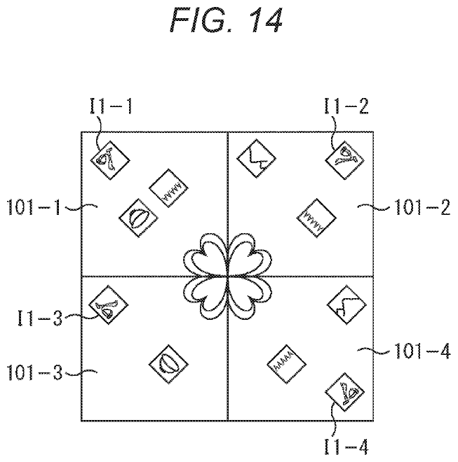

FIG. 12 and FIG. 13 are diagrams illustrating exemplary screen transitions on task registration.

For example, in a case where the user U2 inputs “cleaning” as a task to be registered (step S14 in FIG. 9), an image indicating the cleaning task is displayed in the arrangement region 111-2 as illustrated at the left end of FIG. 12.

A task to be registered is input by a button displayed on the task management screen 101 or by speech as described above. The image indicating the cleaning task is displayed in the operation region 101-2, and the task may be input by the operation of moving the image to the arrangement region 111-2.

Subsequently, in a case where the user U4 inputs cleaning as a task to be registered, the image indicating the cleaning task is displayed in the arrangement region 111-4 as illustrated ahead of the arrow #11.

The user U2 and the user U4 each input an expiration for the cleaning task as needed (step S15 in FIG. 9).

In a case where the user U2 and the user U4 do high fives, for example, while they input the same cleaning task as a task to be registered, the fact is detected (step S16 in FIG. 9), and the arrangement region 111-2 and the arrangement region 111-4 are connected with a straight line L1 as illustrated ahead of the arrow #12.

The connecting is included in the processing performed depending on a combination of users who have performed the specific operation (step S17 in FIG. 9).

In a case where the user U1 and the user U2 input cleaning as a task to be registered while the task management screen 101 illustrated at the right end of FIG. 12 is displayed, the image indicating the cleaning task is displayed in the arrangement region 111-1 and the arrangement region 111-4 as illustrated at the left end of FIG. 13.

In a case where the user U1 and the user U3 do high fives and then the user U1 and the user U2 do high fives in this state, for example, the arrangement region 111-1 and the arrangement region 111-3 are connected with a straight line L2 and the arrangement region 111-1 and the arrangement region 111-2 are connected with a straight line L3 at the respective timings as illustrated ahead of the arrow #13.

Subsequently, in a case where the user U4 does high fives with the users U1, U2, and U3, respectively, the respective arrangement regions are connected with straight lines. Thereafter, the state of the task management screen 101 is such that the icons I1-1 to I1-4 are displayed near the arrangement regions 111-1 to 111-4, respectively, as illustrated ahead of the arrow #14. The icons I1-1 to I1-4 are reduced images of the images displayed in the arrangement regions 111-1 to 111-4, respectively, and indicate that the cleaning task is registered.

In this way, the task is registered by use of UI by which who are registered as persons in charge can be intuitively known. The users using the display regions connected with a straight line are registered as persons in charge.

FIG. 14 is a diagram illustrating exemplary display of the task management screen 101.

The state of the task management screen 101 illustrated in FIG. 14 indicates a state in which a list of registered tasks is displayed. The icons displayed in the operation regions 101-1 to 101-4 indicate the tasks, respectively. The task registration using the above display is repeatedly performed, and thus a plurality of icons indicating the registered tasks is displayed in the task management screen 101. The icons I1-1 to I1-4 indicating the cleaning task are displayed at the predetermined positions in the operation regions 101-1 to 101-4, respectively.

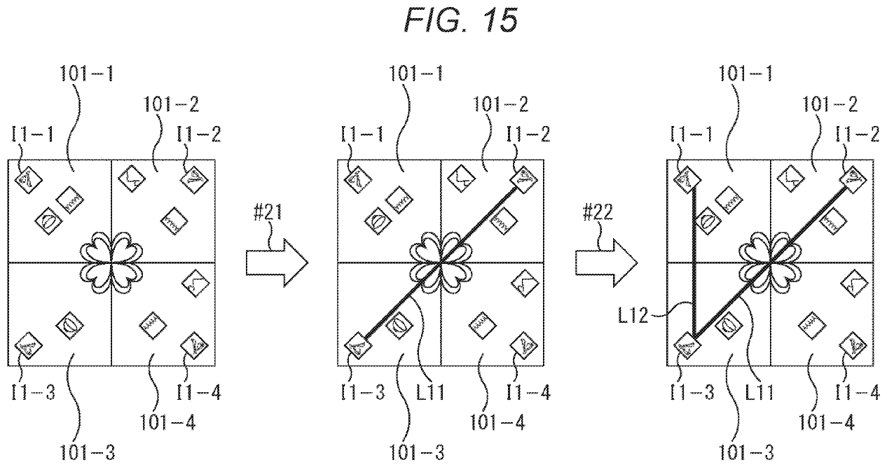

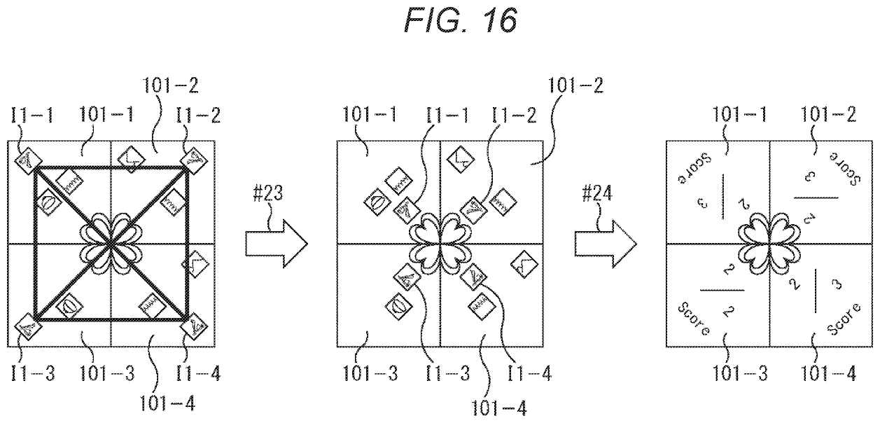

FIG. 15 and FIG. 16 are diagrams illustrating exemplary screen transitions on the task completion.

For example, in a case where the users U1 to U4 each finish the cleaning task and select cleaning as a task to be completed (step S18 in FIG. 9), the icons I1-1 to I1-4 are displayed at the corners close to the users in the operation region 101-1 to 101-4, respectively, as illustrated at the left end of FIG. 15.

That is, the state illustrated in FIG. 14 indicates that only the user U3 does not input a task to be completed. In a case where the user U3 selects cleaning as a task to be completed, the icon I1-3 moves to the corner of the operation region 101-3 as illustrated at the left end of FIG. 15.

A task to be completed is selected by a button displayed on the task management screen 101 or by speech as described above. The task may be input by an operation of moving the icon indicating the cleaning task to the corner of each display region. For example, the tip of a finger is touched on the icon and dragged so that the position of the icon is moved for display.

In a case where the user U2 and the user U3 do high fives while the users U1 to U4 select the same cleaning task as a task to be completed, the fact is detected (step S19 in FIG. 9), and the icon I1-2 and the icon I1-3 are connected with a line L11 as illustrated ahead of the arrow #21.

The connecting is included in the processing performed depending on a combination of users who have performed the specific operation (step S20 in FIG. 9).

Subsequently, in a case where the user U1 and the user U3 do high fives and the fact is detected, the icon I1-1 and the icon I1-3 are connected with a straight line L12 as illustrated ahead of the arrow #22.

Similarly, in a case where the users do high fives and the fact is detected, the icons I1-1 to I1-4 are connected with straight lines, respectively, as illustrated at the left end of FIG. 16.

After all the family members do high fives and the display at the left end of FIG. 16 is made, the icons I1-1 to I1-4 move to the center of the screen and an animation indicating that the respective icons disappear is displayed as illustrated ahead of the arrow #23. A firework animation is displayed, for example, together with the animation indicating that the icons disappear, and an action of celebrating that all the family members have finished the task is performed.

After the end of each action, the state of the task management screen 101 enters a state displaying the scores of the respective users as illustrated ahead of the arrow #24. The score indicates the rate of the number of completed tasks relative to the number of registered tasks. Each user can confirm the number of uncompleted tasks from the display.

The display of the task management screen 101 is switched as described above so that each user can intuitively manage the tasks while making communication with the family members.

How to express each task in the task management screen 101 can be changed as needed. For example, the size or color of an icon indicating a task may be changed depending on the expiration of the task or the degree of importance of contents of the task. For example, an icon of a task closer to its expiration is more largely displayed, or more emphasized and displayed in an eye-catching color.

### <<3.8 Exemplary Detection of Contacting Operation>

It is assumed above that mainly the contacting operations such as high five or handshake are detected on the basis of the sensor data detected by the sensor apparatus 13, but the operations may be detected in other way.

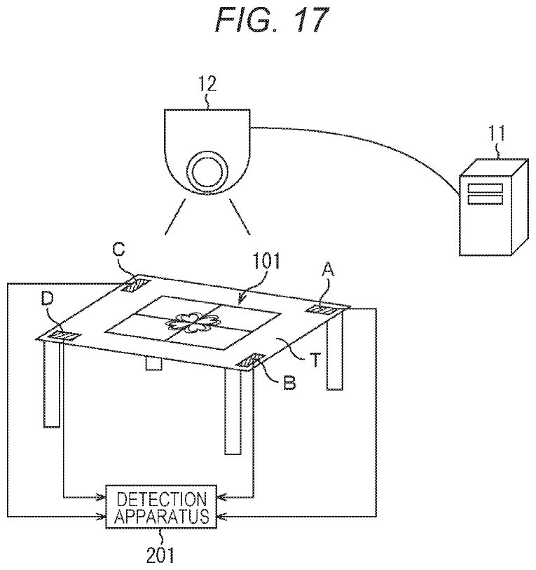

FIG. 17 is a diagram illustrating other exemplary configuration of the information processing system 1.

The same components as the components described with reference to FIG. 1 and the like in the components illustrated in FIG. 17 are denoted with the same reference numerals, respectively. A repeated description will be omitted as needed.

In the example of FIG. 17, the task management screen 101 is projected on the table T. The users U1 to U4 manage the tasks by use of the task management screen 101 as described above.

As shaded in FIG. 17, electrodes A to D are provided at predetermined positions such as the corners of the top of the table T, for example. The electrodes A to D are each connected to a detection apparatus 201 provided instead of the sensor apparatus 13. The detection apparatus 201 is capable of detecting who have performed the contacting operation on the basis of a variation in voltage. The detection apparatus 201 is attached on the backside of the top of the table T or the like, for example.

The users U1 to U4 who manage the tasks by use of the task management screen 101 each operate the task management screen 101 while contacting the electrode close to them by their hand, and perform the contacting operation such as high five or handshake by use of the other hand as needed. For example, the user U1 contacts the electrode A in one hand and the user U2 contacts the electrode B in one hand. Further, the user U3 contacts the electrode C in one hand, and the user U4 contacts the electrode D in one hand.

The detection result by the detection apparatus 201 is transmitted to the information processing apparatus 11 via wireless or wired communication. The detection result transmitted by the detection apparatus 201 is input into the processing control part 57 in the information processing apparatus 11 to be used for specifying the users who have performed the contacting operation, for example.

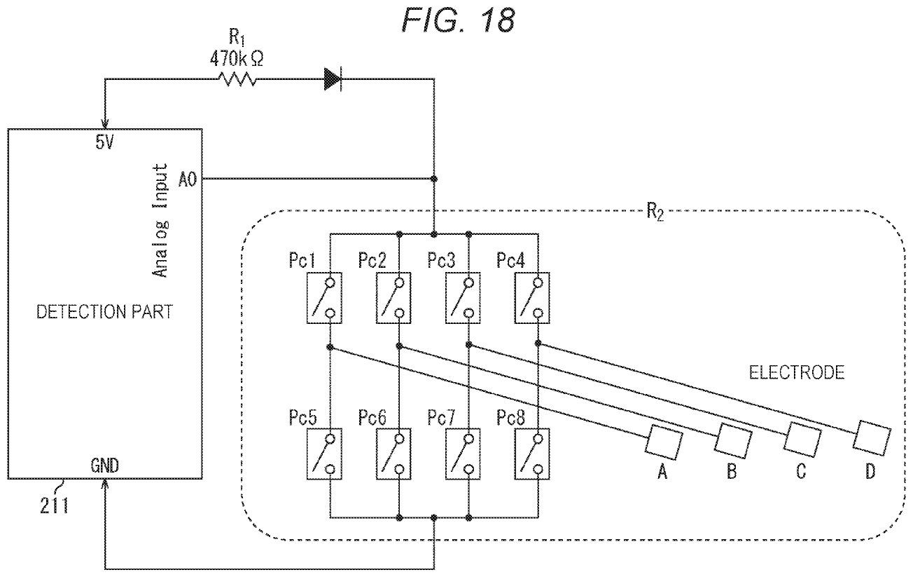

FIG. 18 is a diagram illustrating an exemplary circuit configuration including the configuration of the detection apparatus 201.

As illustrated in FIG. 18, a resistor R1 (pull-up resistor) is connected to an output terminal of a detection part 211 configuring the detection apparatus 201, and photocouplers Pc1 to Pc8 configuring a photocoupler relay are provided at the tip of the resistor R1. The photocoupler Pc1, the photocoupler Pc2, the photocoupler Pc3, and the photocopier Pc4 are connected to the photocoupler Pc5, the photocoupler Pc6, the photocoupler Pc7, and photocoupler Pc8 in series, respectively.

The electrode A is connected between the photocoupler Pc1 and the photocoupler Pc5, the electrode B is connected between the photocoupler Pc2 and the photocoupler Pc6, the electrode C is connected between the photocoupler Pc3 and the photocoupler Pc7, and the electrode D is connected between the photocoupler Pc4 and the photocoupler Pc8. The photocoupler relay and the respective electrodes surrounded in a dotted line are indicated as resistor R2. The resistor R2 is a physical electric resistance via the bodies of the users U1 to U4.

A voltage between the resistor R1 and the resistor R2 is input into an input terminal (analog input terminal) of the detection part 211. The detection part 211 transmits the information indicating a variation in voltage input into the input terminal to the information processing apparatus 11.

In the thus-configured circuit, a combination of ON/OFF of the photocoupler relay is switched in a predetermined pattern at high speed thereby to detect a variation in voltage. For example, one of the photocouplers Pc1 to Pc4 illustrated in the upper part and one of the photocouplers Pc5 to Pc8 illustrated in the lower part are turned ON at the same time and the other six photocouplers are turned OFF at a timing.

For example, in a case where a decrease in voltage is detected at a timing when the photocoupler Pc1 and the photocoupler Pc6 are ON, the fact indicates that the user U1 contacting the electrode A and the user U2 contacting the electrode B perform the contacting operation in their empty hands.

Further, in a case where a decrease in voltage is detected at a timing when the photocoupler Pc3 and the photocoupler Pc8 are ON, the fact indicates that the user U3 contacting the electrode C and the user U4 contacting the electrode D perform the contacting operation in their empty hands.

The detection part 211 transmits the information indicating the decrease in voltage to the information processing apparatus 11. The information processing apparatus 11 specifies who have performed the contacting operation on the basis of the information transmitted from the detection apparatus 201.

In this way, who have performed the contacting operation may be specified on the basis of a decrease in voltage value in physical electric resistance caused when the users contacting the electrode contact each other.

### 4. Application of Information Processing System (Application to Parental Lock)

The description will be made below assuming that the information processing system 1 is applied to a system for executing a limitation management application as an application for managing parental lock.

The information processing system 1 realized when the information processing apparatus 11 executes the limitation management application is used by a parent and a child thereby to achieve promoted communication between the parent and the child via parental lock. For example, the description will be made assuming that a parent restricts a child from eating snacks.

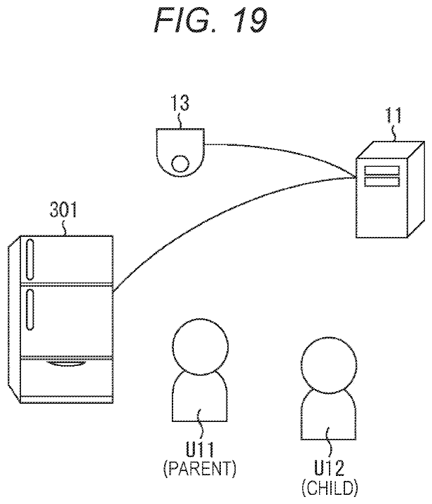

FIG. 19 is a diagram illustrating an exemplary configuration of the information processing system 1 realizing parental lock.

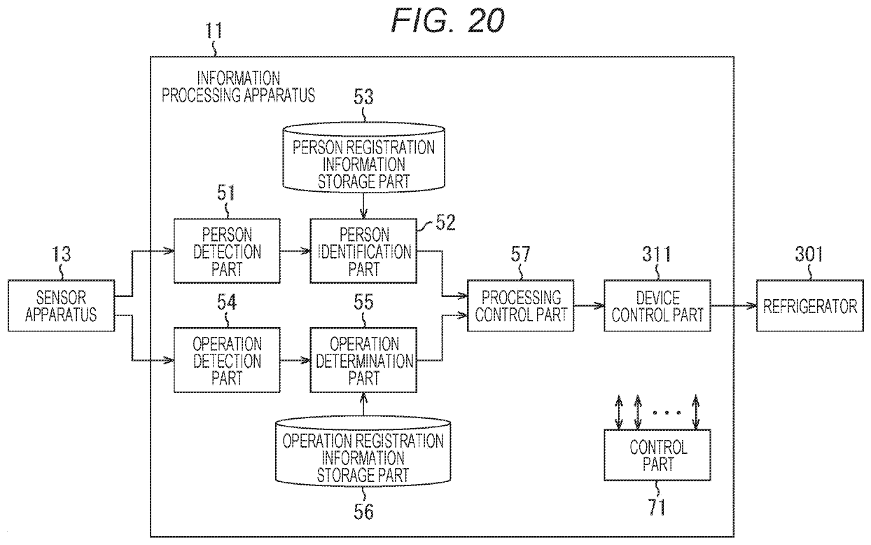

The same components as the components described with reference to FIG. 1 and the like in the components illustrated in FIG. 19 are denoted with the same reference numerals, respectively. A repeated description will be omitted as needed. This is applicable in and subsequent to FIG. 20.

In the information processing system 1 illustrated in FIG. 19, a refrigerator 301 having a door open/close mechanism is provided as a device to be controlled. The refrigerator 301 makes communication with the information processing apparatus 11 via wireless or wired communication, and its door is opened/closed under control of the information processing apparatus 11. The sensor apparatus 13 configured of a depth sensor or the like is provided near the refrigerator 301.

For example, opening/closing the refrigerator 301 is controlled so that the child U12 is restricted from eating an ice cream in the refrigerator 301 as needed. The parent U11 performs a specific operation such as high five together with the child U12 thereby to approve the child U12's action of eating snacks.

To the contrary, the parent U11 does not perform the specific operation such as high five thereby to restrict the child U12 from eating snacks. There is a relationship between the parent U11 as approved person and the child U12 as unapproved person.

In a case where the information processing apparatus 11 detects that the parent U11 and the child U12 have performed the specific operation on the basis of the sensor data transmitted from the sensor apparatus 13, it controls the refrigerator 301 and unlocks the door. The information processing apparatus 11 controls in a case where who is trying to open the door of the refrigerator 301 is recognized and the child U12 is trying to open the door.

FIG. 20 is a block diagram illustrating an exemplary functional configuration of the information processing apparatus 11 realizing the information processing system 1 of FIG. 19.

As illustrated in FIG. 20, the information processing apparatus 11 is provided with a device control part 311 instead of the video display control part 58 of FIG. 5. The device control part 311 controls the communication part 38 and makes communication with the refrigerator 301, and controls holding/releasing the locked state of the door of the refrigerator 301 on the basis of a determination result of the processing control part 57.

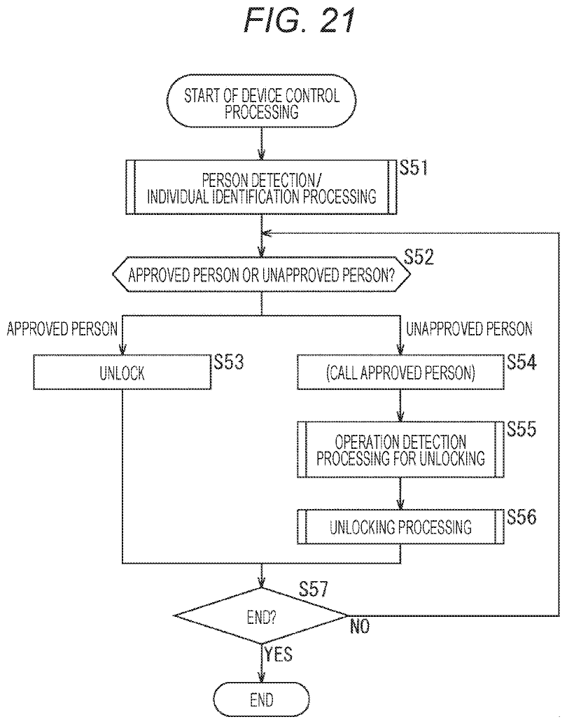

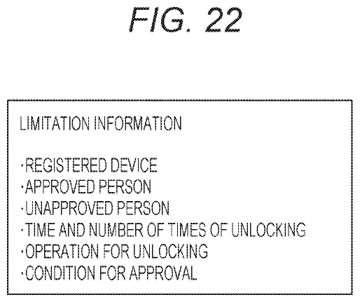

Device control processing of the information processing apparatus 11 for executing the limitation management application will be described with reference to the flowchart of FIG. 21.

Person detection/individual identification processing is performed in step S51. The person detection/individual identification processing performed in step S51 corresponds to the processing in step S1 in FIG. 6.

That is, a user present around the refrigerator 301 is detected and the detected user is identified on the basis of the depth information input as sensor data. The person registration information for identifying the respective users configuring the family including the parent U11 and the child U12 is stored in the person registration information storage part 53.

In step S52, the processing control part 57 determines whether the user present around the refrigerator 301 is the parent U11 set as approved person or the child U12 set as unapproved person.

In a case where it is determined in step S52 that the user present around the refrigerator 301 is the parent U11 set as approved person, the refrigerator 301 is unlocked in step S53. That is, the device control part 311 controls the refrigerator 301 and unlocks its door.

On the other hand, in a case where it is determined in step S52 that the user present around the refrigerator 301 is the child U12 set as unapproved person, the child U12 as unapproved person calls the parent U11 as approved person in step S54. In step S54, the information processing apparatus 11 waits for the parent U11 to be called. The fact that the parent U11 is called is specified in the processing similar to the person detection/individual identification processing in step S51.

In a case where the parent U11 is called, operation detection processing for unlocking is performed in step S55.

In a case where it is detected that the parent U11 and the child U12 have performed the operation for unlocking, the unlocking processing is performed in step S56.

After the unlocking in step S53 or step S56, whether or not to terminate the processing is determined in step S57. In a case where it is determined in step S57 that the processing is not to be terminated, the processing returns to step S52 and the above processing is repeatedly performed. On the other hand, in a case where it is determined in step S57 that the processing is to be terminated, the processing is terminated.

The system in which processing is performed depending on a combination of users who perform the specific operation for unlocking is realized in the above processing. When a combination of users who perform the specific operation is a combination of the approved parent U11 and the unapproved child U12, the unlocking processing is performed, and the unlocking processing is not performed in other combinations of users. Thereby, communication between the parent and the child can be promoted via parental lock.

### <<4.1 Registration>>

Various settings such as registering a device to be controlled and registering a function to be controlled are required for the pre-processing for parental lock using the information processing system 1.

### <4.1.1 Registration of Device to be Controlled>

The information processing apparatus 11 for executing the limitation management application and the refrigerator 301 as a device to be controlled are connected via a network. The information processing apparatus 11 makes communication with the refrigerator 301 thereby to receive information associated with the functions of the refrigerator 301, for example, and to register the device information for controlling the refrigerator 301.

### <4.1.2 Registration of Locking Function>

The information processing apparatus 11 for executing the limitation management application makes communication with the refrigerator 301 in response to an operation by the parent U11 as approved person, for example, and sets the locking function for the refrigerator 301 when a predetermined object such as ice cream is put therein. The setting can be performed in response to a speech operation.

The locking function may be set on the basis of age, sex, or the like included in the user-associated information irrespective of objects put in the refrigerator 301. The unlocking conditions (such as domestic work or homework for the child U12) may be set.

### <4.1.3 Approved Person, Designation of Authority, Transfer of Agent Authority>

Who is an approved person, who is an unapproved person, and the authority of the approved person are set depending on an operation of the parent U11, for example. The information processing apparatus 11 manages the limitation information indicating the setting contents. The approved person and the like are set by operating a button of the refrigerator 301 or the parent U11 operating his/her portable terminal, for example.

The approved person or the authority contents may be automatically determined on the basis of age, sex, or the like included in the user-associated information. For example, the persons over a predetermined age are authorized to open the door of the refrigerator 301.

The approved person, the unapproved person, and the like may be set by a speech operation. The parent U11 as approved person may set an agent person and the authority of the approved person may be given to the agent.

### <<4.2 Use of Unapproved Person>>

### <4.2.1 Start of Application>

In a case where it is detected that the child U12 as unapproved person is near the refrigerator 301 and is trying to open the door of the refrigerator 301, the limitation management application may be activated. After the limitation management application is activated, the pieces of processing in and subsequent to step S54 are performed.

The limitation management application may be activated when the child U12 performs a predetermined operation. For example, the limitation management application is activated by a speech operation. At this time, whether or not the condition that the child U12 has performed his/her homework or domestic work, or the like is satisfied may be checked.

### <4.2.2 Calling Approved Person>

The approved person is called in step S54 when the child U12 notifies the parent U11 by use of his/her Smartphone, for example. The approved person may be called via announcement using a household speaker. The unapproved person may directly call the approved person.

### <4.2.3 Operation Detection Processing for Unlocking>

The operation detection processing for unlocking performed in step S55 corresponds to the processing in step S3 in FIG. 6. That is, the processing similar to the processing described in 2.2 is performed, and the operations of the called parent U11 and the child U12 are detected by the operation detection part 54. Further, whether or not the detected operation is the operation for unlocking is determined by the operation determination part 55, and the determination result is output to the processing control part 57.

In a case where the parent U11 and the child U12 identified by the person identification part 52 perform the operation for unlocking, the processing control part 57 outputs the information indicating the fact to the device control part 311.

The parent U11 may confirm the conditions for unlocking before performing the operation for unlocking such as high five.

### <4.2.4 Unlocking Processing>

The door of the refrigerator 301 is unlocked by the device control part 311 in the unlocking processing performed in step S56. Thereby, the child U12 can open the door of the refrigerator 301 and take out an ice cream therefrom.

The door of the refrigerator 301 is kept unlocked for a certain time, for example. The door enters unlocked again after the certain time elapses.

### <<4.3 Data Structure>>

FIG. 22 is a diagram illustrating an exemplary data structure of the limitation information.

As illustrated in FIG. 22, the limitation information includes information indicating registered device, approved person, unapproved person, unlocked time, number of times of unlocking, operation for unlocking, and condition for approval. The conditions for approval is to do homework, to perform a task, and to evaluate daily operations (brushing teeth, eating vegetables, going to bet by 0 o'clock, and the like).

### 5. Effects and Variants

The opportunities of face-to-face communication can be increased by use of the information processing system 1. Conversation is of course required for performing a contacting operation or the like, and the above processing leads to an increase in opportunities to make conversion.

Users perform an operation together thereby to register a task, then perform the task together, and then perform an operation together thereby to complete the task, and thus they have many opportunities to act together so that the users of the information processing system 1 can feel a sense of achievement or a sensor of cooperation. Thereby, it can be expected that the users form friendships or achieve better teamwork.

Various operations can be used as a trigger operation, and various pieces of processing can be used as processing performed by the information processing apparatus 11 in response to a trigger operation. For example, in a case where the information processing system 1 is provided in a bar, photographing may be performed in response to a trigger operation of touching glasses in a toast. Processing contents may be changed depending on a combination of users, and for example, an animation is shot when a combination of users who touch glasses in a toast is a combination of males, and a still image is shot in a combination of females.

Further, the function of the limitation management application can restrict a specific person from performing a specific action alone. A device to be controlled is not limited to a refrigerator, and may be various devices.

For example, a game machine or a safe may be to be limited. As for processing for security such as unlocking the door of a safe, the door may be controlled and unlocked when a plurality of registered users is present around the safe.

### Variants of Configuration

The information processing apparatus 11 may be provided as an apparatus on a network, and communication between the information processing apparatus 11 and the video display apparatus 12 and communication between the information processing apparatus 11 and the sensor apparatus 13 may be each made via a network such as the Internet.

The functions of the video display apparatus 12 and the functions of the sensor apparatus 13 are mounted on one apparatus, and additionally the functions of the information processing apparatus 11 may be also mounted on one apparatus.

Further, the components of the information processing apparatus 11 illustrated in FIG. 5 and the like may be realized on a plurality of apparatuses. In this case, the plurality of apparatuses dividing and realizing the components of the information processing apparatus 11 illustrated in FIG. 5 is connected with each other via a network.

### Other Examples

It is assumed above that a user who performs a specific operation is around the Table T, but users who are away from each other perform an operation together, and thus processing may be performed in response to the operation.

For example, in a case where the user U1 and the user U2 are far away and it is detected that they have performed a specific operation at the same timing, the information processing apparatus 11 performs processing depending on a combination of the user U1 and the user U2 who have performed the specific operation. In this case, the information processing apparatus 11 detects the operation of the user U1 on the basis of the sensor data transmitted from the sensor apparatus 13 installed in the space where the user U1 is present, and detects the operation of the user U2 on the basis of the sensor data transmitted from the sensor apparatus 13 installed in the space where the user U2 is present.

Communication between users can be promoted also in the pieces of processing, though not face-to-face communication.

Predetermined processing may be performed when users present in the same virtual space perform a specific operation.

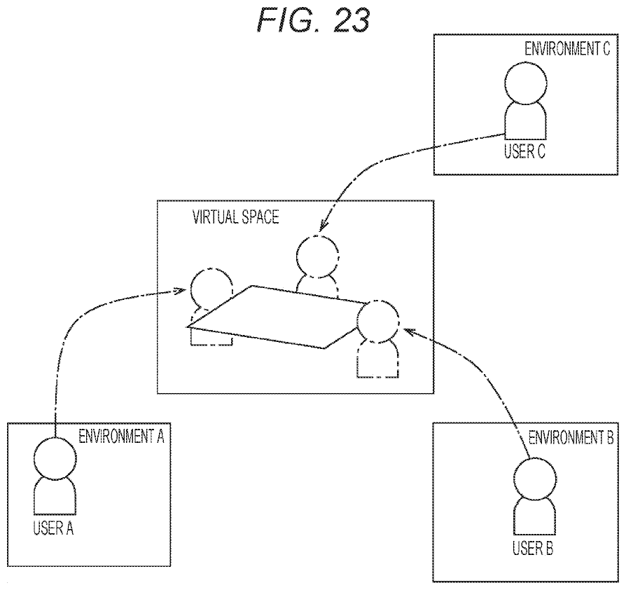

FIG. 23 is a diagram illustrating exemplary users in the same virtual space.

In the example of FIG. 23, environments A to C as environments (places) away from each other are illustrated, and users A to C are assumed to be present in the environments, respectively. The virtual space is realized by a server, for example.

For example, the uses A to C area user who mounts a head mounted display (HMD) for virtual reality (VR) or augmented reality (AR) or a user who is in an environment on which a video of the virtual space is projected. The users A to C operate their own apparatus and participate in a community in the virtual space, thereby making communication with other users participating in the same community.

Various pieces of processing as described above may be performed when a plurality of users performs a specific operation in such a situation.

### Exemplary Configuration of Computer

A series of processing described above can be performed in hardware or may be performed in software. In a case where the pieces of processing are performed in software, a program configuring the software is installed in a computer incorporated in dedicated hardware, a general-purpose personal computer, or the like from a program recording medium.

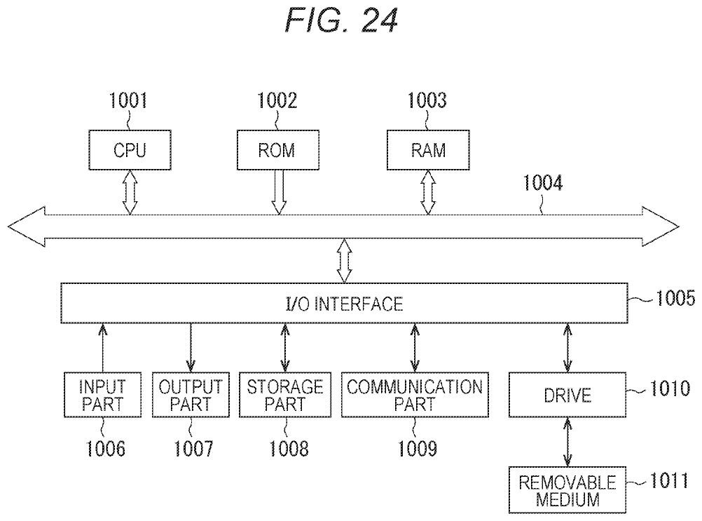

FIG. 24 is a block diagram illustrating an exemplary hardware configuration of a computer for performing the pieces of processing by the programs.

A CPU 1001, a ROM 1002, and a RAM 1003 are mutually connected via a bus 1004.

The bus 1004 is further connected with an I/O interface 1005. The I/O interface 1005 is connected with an input part 1006 configured of a keyboard, a mouse, and the like, and an output part 1007 configured of a display, a speaker, and the like. Further, the I/O interface 1005 is connected with a storage part 1008 configured of a hard disc, a nonvolatile memory, or the like, a communication part 1009 configured of a network interface or the like, and a drive 1010 for driving a removable medium 1011.

In the thus-configured computer, the CPU 1001 loads and executes the programs stored in the storage part 1008 into the RAM 1003 via the I/O interface 1005 and the bus 1004, for example, so that the pieces of processing are performed.

The programs executed by the CPU 1001 are recorded in the removable medium 1011, for example, or provided via a wired or wireless transmission medium such as local area network, Internet, or digital broadcasting to be stored in the storage part 1008.

Additionally the programs executed by the computer may be programs executed in time series in the order described in the present specification or may be programs executed in parallel or at necessary timings such as on calling.

In the present specification, a system indicates a collection of a plurality of components (such as apparatuses and modules (parts)), and all the components may be or may not be in the same casing. Therefore, a plurality of apparatuses housed in separate casings and connected via a network, and one apparatus in which a plurality of modules is housed in one casing are a system.

Embodiments of the present technology are not limited to the above embodiment, and variously changed within the scope without departing from the spirit of the present technology.

For example, the present technology can take a Cloud computing configuration in which one function is divided into a plurality of apparatuses via a network and processed in cooperation.

Further, each step described in the above flowcharts can be performed in one apparatus, and can be divided and performed in a plurality of apparatuses.

Further, in a case where one step includes a plurality of pieces of processing, the plurality of pieces of processing included in one step can be performed in one apparatus, or can be divided and performed in a plurality of apparatuses.

Additionally, the effects described in the present specification are merely exemplary, and are not restrictive, and other effects can be obtained.

### Exemplary Combinations of Configurations

The present technology can take the following configurations.

(1)

An information processing apparatus including:

an individual identification part configured to identify a plurality of persons;

an operation detection part configured to detect a specific operation performed by the plurality of persons together; and

a processing control part configured to perform processing depending on a combination of the plurality of persons in a case where the specific operation is detected.

(2)

The information processing apparatus according to (1),

in which the operation detection part detects the specific operation performed by the plurality of persons who are close to each other.

(3)

The information processing apparatus according to (1) or (2),

in which the operation detection part detects an operation performed by the plurality of persons who contact each other as the specific operation.

(4)

The information processing apparatus according to (1) or (2),

in which the operation detection part detects an operation in which the plurality of persons issues a predetermined word as the specific operation.

(5)

The information processing apparatus according to any of (1) to (4),

in which the individual identification part identifies the plurality of previously-registered persons on the basis of information detected by a sensor or on the basis of an input operation by the plurality of persons.

(6)

The information processing apparatus according to any of (1) to (5),

in which in a case where a task to be registered is selected on a management screen used for task management and the specific operation is detected, the processing control part registers the task to be registered as a task performed by the plurality of persons who perform the specific operation in cooperation.

(7)

The information processing apparatus according to (6),

in which the processing control part stores task information including information indicating contents of registered task, expiration, a person in cooperation, and operation at the end of task.

(8)

The information processing apparatus according to (7),

in which in a case where it is detected that a person expressed by the task information performs an operation at the end of a task as the specific operation, the processing control part manages assuming that the task with contents expressed by the task information ends.

(9)

The information processing apparatus according to any of (6) to (8),

in which the processing control part controls displaying the management screen such that display of the management screen is changed depending on a combination of the plurality of persons in a case where the specific operation is detected.

(10)

The information processing apparatus according to any of (6) to (9),

in which the processing control part controls displaying the management screen projected by a projection apparatus.

(11)

The information processing apparatus according to any of (1) to (5),

in which the processing control part performs processing of unlocking a device to be controlled.

(12)

An information processing method including the steps of:

identifying a plurality of persons;

detecting a specific operation performed by the plurality of persons together; and

performing processing depending on a combination of the plurality of persons in a case where the specific operation is detected.

(13)

A program for causing a computer to perform processing including the steps of:

identifying a plurality of persons;

detecting a specific operation performed by the plurality of persons together; and

performing processing depending on a combination of the plurality of persons in a case where the specific operation is detected.

### REFERENCE SIGNS LIST

1 Information processing system
11 Information processing apparatus
12 Video display apparatus
13 Sensor apparatus
51 Detection part
52 Person identification part
53 Person registration information storage part
54 Operation detection part
55 Operation determination part
56 Operation registration information storage part
57 Processing control part
58 Video display control part
71 Control part
311 Device control part

1. An information processing apparatus comprising:
an individual identification part configured to identify a plurality of persons;
an operation detection part configured to detect a specific operation performed by the plurality of persons together; and
a processing control part configured to perform processing depending on a combination of the plurality of persons in a case where the specific operation is detected.

2. The information processing apparatus according to claim 1,
wherein the operation detection part detects the specific operation performed by the plurality of persons who are close to each other.

3. The information processing apparatus according to claim 1,
wherein the operation detection part detects an operation performed by the plurality of persons who contact each other as the specific operation.

4. The information processing apparatus according to claim 1,
wherein the operation detection part detects an operation in which the plurality of persons issues a predetermined word as the specific operation.

5. The information processing apparatus according to claim 1,
wherein the individual identification part identifies the plurality of previously-registered persons on a basis of information detected by a sensor or on a basis of an input operation by the plurality of persons.

6. The information processing apparatus according to claim 1,
wherein in a case where a task to be registered is selected on a management screen used for task management and the specific operation is detected, the processing control part registers the task to be registered as a task performed by the plurality of persons who perform the specific operation in cooperation.

7. The information processing apparatus according to claim 6,
wherein the processing control part stores task information including information indicating contents of registered task, expiration, a person in cooperation, and operation at the end of task.

8. The information processing apparatus according to claim 7,
wherein in a case where it is detected that a person expressed by the task information performs an operation at the end of a task as the specific operation, the processing control part manages assuming that the task with contents expressed by the task information ends.

9. The information processing apparatus according to claim 6,
wherein the processing control part controls displaying the management screen such that display of the management screen is changed depending on a combination of the plurality of persons in a case where the specific operation is detected.

10. The information processing apparatus according to claim 6,
wherein the processing control part controls displaying the management screen projected by a projection apparatus.

11. The information processing apparatus according to claim 1,
wherein the processing control part performs processing of unlocking a device to be controlled.

12. An information processing method comprising the steps of:
identifying a plurality of persons;
detecting a specific operation performed by the plurality of persons together; and
performing processing depending on a combination of the plurality of persons in a case where the specific operation is detected.

13. A program for causing a computer to perform processing comprising the steps of:
identifying a plurality of persons;
detecting a specific operation performed by the plurality of persons together; and
performing processing depending on a combination of the plurality of persons in a case where the specific operation is detected.
